(19) United States
(12) Patent Application Publication
(10) Pub. No.: US 2023/0196853 A1
(43) Pub. Date: Jun. 22, 2023

(54) SYSTEM AND METHOD FOR MANAGING AN ELECTRIC CAR CHARGING ECOSYSTEM

(71) Applicant: Jeffrey R. Ambroziak, Guilford, CT (US)

(72) Inventor: Jeffrey R. Ambroziak, Guilford, CT (US)

(21) Appl. No.: 17/992,878

(22) Filed: Nov. 22, 2022

Related U.S. Application Data
(60) Provisional application No. 63/282,278, filed on Nov. 23, 2021.

(51) Int. Cl. G07C 5/08; G07C 5/00

(52) U.S. Cl. CPC G07C 5/0825; G07C 5/008; G07C 5/004

(57) ABSTRACT

A system includes a processor and a memory in communication with the processor, the memory storing instructions that when executed by the processor cause the processor to receive charge data from a plurality of electric vehicles comprising a first charge node, display on a touchscreen device the charge data for each of the plurality electric vehicles, receive one or more user instructions each defining a desired charging attribute for at least one of the plurality of electric vehicles and transmit, based upon, at least, one of the received user instructions, updated charge data to at least one of the plurality of electric vehicles.

### CROSS REFERENCE TO RELATED APPLICATIONS

This application claims the benefit of U.S. Provisional Pat. Application 63/282,278, filed Nov. 23, 2021, entitled “SYSTEM AND METHOD FOR MANAGING AN ELECTRIC CAR CHARGING ECOSYSTEM”, the entire disclosure of which is hereby incorporated herein by reference.

### FIELD OF THE INVENTION

The present invention relates to methods and systems for managing an electric car ecosystem.

### BACKGROUND

The advent of fully electric and electric hybrid vehicles has given rise to dual phenomena comprised of range anxiety and charge anxiety. Range anxiety is the fear that a vehicle has insufficient range to reach its destination and would thus strand the vehicle’s occupants. Such anxiety has been substantially alleviated as the result of car batteries having the capacity to store a charge sufficient to power a vehicle approximately 200 miles. As a result, charging anxiety has increasingly been cited as the primary worry amongst electric car owners. Specifically, charge anxiety arises from an inability to form a clear mental picture and understanding of how much a car is charged at present, the extent to which such a charge is able to propel a vehicle, how long it will take to charge an electric vehicle to an amount suitable for one’s needs at any given moment or at a moment in the future and where one can obtain needed charge.

Many electric car manufacturers offer an App for execution on a smartphone or other computer platform that permits the real-time, or near real-time, interrogation of the status of many parameters of an electric vehicle. These Apps are specific to the make and, in many cases, the model of a specific electric vehicle. For example, an App for a Tesla automobile will not interface with a Ford vehicle or a BMW vehicle or the like. As a result, it is not uncommon for a family that owns more than one electric vehicle to jump from App to App when planning an excursion seeking to ascertain the charge state of each car before deciding which car is best charged for the contemplated excursion.

There is therefore a need for a system and interface adapted to gather and display information from a plurality of different electric vehicles, especially wherein at least two of the vehicles are produced by different corporate entities. Combining information from a number of different vehicles serves many purposes. As vehicle batteries increase in the size of the charge they can store, each vehicle becomes one node in a charge ecosystem that may be comprised of, for example, home battery storage units, such as the Tesla Powerwall and one or more vehicle batteries. In addition, charge may be acquired from renewable sources, such as a solar array mounted on the roof of a house as well as from an electrical outlet from which electricity produced by a public utility is acquired. There is therefore a further need to gather and display information from a plurality of different nodes forming an ecosystem wherein each node is a producer of electricity, a consumer electricity or some combination of the two including, but not limited, renewable energy sources, home batteries, vehicle batteries, public utility electricity providers and the like.

There is further a need for a system and method directed to controlling such an ecosystem to permit the sale of an individual’s generated power and to enable load balancing and price spike control by public utilities and other electricity providers free of technical and regulatory hurdles.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter’s scope.

### BRIEF DESCRIPTION OF THE FIGURES

In the figures, which are not necessarily drawn to scale, like numerals may describe substantially similar components throughout the several views. Like numerals having different letter suffixes may represent different instances of substantially similar components. The figures illustrate generally, by way of example, but not by way of limitation, certain embodiments discussed in the present document, where:

FIG. 1 is an illustration of a user interface according to an exemplary and non-limiting embodiment;

FIG. 2 is an illustration of a user interface according to an exemplary and non-limiting embodiment;

FIG. 3A is an illustration of a user interface according to an exemplary and non-limiting embodiment;

FIG. 3B is an illustration of a user interface according to an exemplary and non-limiting embodiment;

FIG. 4 is an illustration of a user interface according to an exemplary and non-limiting embodiment;

FIG. 5 is an illustration of schematic diagram of a charge ecosystem forming a part of the system according to an exemplary and non-limiting embodiment;

FIG. 6A is an illustration of a user interface according to an exemplary and non-limiting embodiment;

FIG. 6B is an illustration of a state diagram according to an exemplary and non-limiting embodiment;

FIG. 7A is an illustration of a state diagram according to an exemplary and non-limiting embodiment;

FIG. 7B is an illustration of a user interface according to an exemplary and non-limiting embodiment;

FIG. 7C is an illustration of a user interface according to an exemplary and non-limiting embodiment;

FIG. 8A is an illustration of a state diagram according to an exemplary and non-limiting embodiment;

FIG. 8B is an illustration of a user interface according to an exemplary and non-limiting embodiment; and

FIG. 8C is an illustration of a user interface according to an exemplary and non-limiting embodiment.

### DETAILED DESCRIPTION

### 1. Terms and Definitions

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

As used herein, the term “electric vehicle” may generally refer to any vehicle that utilizes, stores, and/or provides electrical power (e.g., buses, trains, cars, semi-trucks, ships, submarines, aircraft, dirt bikes, All Terrain Vehicles (ATV), scooters, and/or lawn mowers). Almost all typical vehicles comprise a battery, for example, and would thus qualify as “electric vehicles”. Similarly, the term “electric car” as utilized herein may generally refer to any electric vehicle that may suitably be described as a car. This may include, in some embodiments, passenger cars of any size or class or configuration, passenger trucks such as pickup trucks, vans, etc. Some embodiments are more specifically directed to and/or may be particularly advantageously applied to certain types or classes of electric vehicles and/or electric cars. Electric-drive vehicles or “True Electric Cars (TEC)”, for example, comprise a class of vehicles that derive power (and thus motion) by utilizing one or more electric motors. Some electric-drive vehicles may store energy for powering such motors in one or more batteries (the typical configuration for a TEC). Some electric-drive vehicles may instead utilize power obtained from operation of a small internal combustion engine, fuel cell, or the like. This class of vehicle is typically referred to as a “hybrid” electric vehicle.

Some embodiments described herein are associated with a “control system” or “system”. As used herein, the term “control system” or “system” may generally refer to any combination of hardware, software, firmware, and/or microcode that is operative to carry out and/or facilitate embodiments described herein. For example, a control system may comprise a processor performing instructions of a program to facilitate intelligent vehicle charging. The control system may comprise, according to some embodiments, a single device and/or component or may comprise any practicable number of networked devices. In addition, the system may incorporate numerous data storage devices and processors working cooperatively across platforms to perform described functionality.

Some embodiments described herein are associated with a “network device”. As used herein, the term “network device” may generally refer to any device that can communicate via a network. Examples of network devices include a PC, a workstation, a server, a printer, a scanner, a facsimile machine, a copier, a PDA, a storage device (e.g., a disk drive), a hub, a router, a switch, and a modem or a wireless phone. In some embodiments, network devices may comprise one or more network components, such as a Static Random Access Memory (SRAM) device or module, a network processor, and/or a network communication path, connection, port, or cable. Some examples of network devices may include, but are not limited to, servers or controllers, customer devices, vehicles and/or vehicle components, input devices, output devices, and peripheral devices.

Some embodiments described herein are associated with an “input device”. As used herein, the term “input device” may generally refer to any device that is used to receive or process input. An input device may communicate with and/or be part of another device (e.g., a wagering game device). Some examples of input devices include, but are not limited to: a button, a key, one or more softkeys and/or variable function input devices, a bar-code scanner, a magnetic stripe reader, a computer keyboard, a pointing device (e.g., a computer mouse, touchpad, and/or trackball), a point-of-sale terminal keypad, a touch-screen, a microphone, an infrared sensor, a sonic ranger, a computer port, a video camera, a motion detector, an accelerometer, a thermometer, a digital camera, a network card, a Universal Serial Bus (USB) port, a Global Positioning System (GPS) receiver, a Radio Frequency Identification (RFID) receiver, a RF receiver, a pressure sensor, and a weight scale or mass balance. In some embodiments, there is illustrated a smartphone. In practice and operation, any display device may be utilized including, but not limited to, an automobile dashboard touchscreen device.

Some embodiments described herein are associated with an “output device”. As used herein, the term “output device” may generally refer to a device that is used to output information. An output device may communicate with and/or be part of another device. Some examples of output devices may include, but are not limited to: a Cathode Ray Tube (CRT) monitor, a Liquid Crystal Display (LCD) screen, a Light Emitting Diode (LED) screen, a printer, an audio speaker (or other sound or noise-producing device), an Infra-red Radiation (IR) transmitter, a RF transmitter, a vibration device, an olfactory emitter, and/or a data port.

It should be understood that some devices may function and/or operate as both input and output devices. A touch-sensitive display device (or “touch screen”), for example, may both receive input by receiving pressure and/or electrostatic indications via a display screen and may also provide output such as graphics, text, and/or other data via the same display screen.

Some embodiments herein are associated with “communication”. As used herein, the term “communication” may refer to any information, data, and/or signal that is provided, transmitted, received, and/or otherwise processed by an entity, and/or that is shared or exchanged between two or more people, devices, and/or other entities. Communications may be external to one or more devices, internal (e.g., within a device and/or component), wired, wireless, continuous, and/or intermittent. Communications may involve, for example, one or more of transmitting, receiving, relaying, processing, and/or otherwise interfacing with information and/or data. Some, but not all, possible communication networks that may be utilized for such communications include: a Local Area Network (LAN), a Wide Area Network (WAN), the Internet, a telephone line (e.g., a Public Switched Telephone Network (PSTN)), a cable line, a radio channel, an optical communications line, and/or a satellite communications link. A variety of communications protocols may be utilized to facilitate and/or conduct such communications, including but not limited to: Ethernet (or IEEE 802.3), Internetwork Packet Exchange IPX), Service Advertising Protocol (SAP), Asynchronous Transfer Protocol (ATP), Bluetooth®, and/or Transmission Control Protocol (TCP)/Internet Protocol (IP). Communications may be encrypted to ensure privacy and prevent fraud in any of a variety of ways that are or become known or practicable.

Devices and/or entities in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time.

As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the IP Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As used herein, the term “coupled” may generally refer to any type or configuration of coupling that is or becomes known or practicable. Coupling may be descriptive, for example, of two or more objects, devices, and/or components that are communicatively coupled, mechanically coupled, electrically coupled, and/or magnetically coupled. The term “communicatively coupled” generally refers to any type or configuration of coupling that places two or more objects, devices, components, or portions, elements, or combinations thereof in communication. Mechanical, electrical, and magnetic communications are examples of such communications. The term “mechanically coupled” generally refers to any physical binding, adherence, attachment, and/or other form of physical contact between two or more objects, devices, components, or portions, elements, or combinations thereof.

The term “electrically coupled” indicates that one or more objects, devices, components, or portions, elements, or combinations thereof, are in electrical contact such that an electrical signal, pulse, or current (e.g., electrical energy) is capable of passing between the one or more objects, enabling the objects to electrically communicate with one another. In some embodiments, electrical coupling may enable electrical energy to be transmitted wirelessly between two or more objects and/or devices. The term “magnetically coupled” indicates that one or more objects, devices, components, or portions, elements, or combinations thereof, are within one or more associated magnetic fields. Objects may be electrically and/or magnetically coupled without themselves being physically attached or mechanically coupled. For example, objects may communicate electrically through various wireless forms of communication or may be within (at least partially) a magnetic field, without being physically touching or even adjacent.

Various indicia and elements, such as those comprising a user interface, may be described as being rendered in colors, such as green and red. In all instances, such descriptions are exemplary and in practice may take the form of any shade of gray, white or black, any other color and/or incorporate any number of graphic forms, such as hachure and cross-hatch rendering and the like sufficient to visually differentiate different indicia and elements.

### II. System Description

As described more fully below, there are times when the collective charging status of all electric cars owned and/or operated by an individual may be partially abstracted and simplified, such as by showing total charge amongst all electric vehicles, as well as instances when such a simplification serves to hinder a useful understanding of the charge state of the one or more vehicles. There is used here the following convention: Car_ID(Charge Capacity, Current Charge, Needed Charge, ΔCharge). For example, Tesla_1(75, 60, 70, -10) refers to a specific automobile, “Tesla_1” that is capable of storing 75 units of charge, is currently charged to 60 units of charge, and requires 70 units of charge leaving it with a deficit of 10 units of charge. In some instances, units may be kWh.

Consider the following two scenarios each involving four cars.

Scenario 1:
Tesla_1(75, 30, 40, -10)
Ford _1(80, 20, 10, +10)
Tesla_2(75, 70, 20, +50)
BMW_1(75, 10, 60, -50)

Scenario 2:
Tesla_1(75, 10, 75, -65)
Ford _1(80, 60, 30, +30)
Tesla_2(75, 75, 65, +10)
BMW_1(75, 35, 10, +25)

In both scenarios, the total charge capacity of the batteries is 305 units with a net charge differential of zero, (-10 + 10 + 50 -50) = 0 and (-65 + 30 + 10 +25) = 0, respectively. However, at such a level of summation and/or abstraction, there is much important information that is lost. For example, in scenario 1, both Ford_1 and Tesla_2 have excess charge available to be utilized while in scenario 2, all vehicles with the exception of Tesla_1 have excess charge. Further, in scenario 1, all of the vehicles collectively have 130 units of charge resulting in storage space for an extra 175 units of charge. In contrast, with regards to scenario 2, all of the vehicles collectively have 180 units of charge resulting in storage space for extra 125 units of charge.

As a result, if all four vehicles were plugged in to the system and capable of charging and discharging and electricity for charging was being rationed, scenario 1 would see only Tesla_1 and BMW_1 charging as they both exhibit a negative ΔCharge. Likewise, in scenario 2, only Tesla_1 would commence to charge.

If, for example, an operator of the vehicles was contemplating a trip requiring 35 units of charge, in scenario_1 only Tesla_2 has enough charge for the trip. In scenario_2, all vehicles with the exception of Tesla_1 have enough charge.

In addition to the current charge, charge capacity and requested charge for a vehicle there are numerous other attributes that are beneficial to display including, but not limited to, charge connectivity, charge enablement, charge source, and the like.

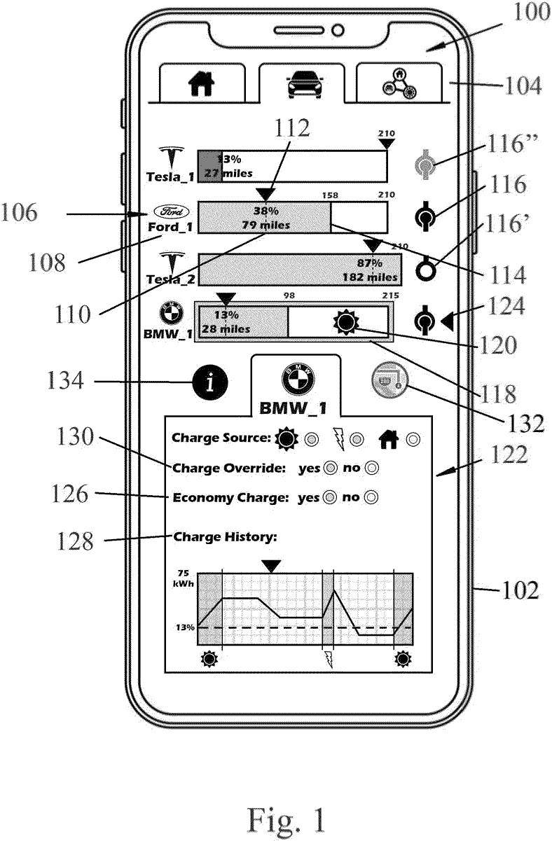

With reference to FIG. 1, there is illustrated an exemplary and non-limiting embodiment of a user interface 100 operating on a computing device 102. In some embodiments, the system components illustrated may be similar in configuration and/or functionality to the system elements illustrated and described with reference to any or all other figures and, as a result, descriptions of FIG. 1 may be combined with the descriptions of any and all other figures. As described below, various graphical elements may be activated by touching the element, clicking upon or otherwise selecting an element. A plurality of tab indicators 104 allow for the selection of various different views of the charging environment as illustrated and as indicated by the home, car and ecosystem icons. As illustrated, a plurality of electrical vehicles is illustrated in summary fashion. While showing four separate vehicles, any number of vehicles may be shown as associated with any number of separate charging nodes. In some instances, a single charge charging at a remote site may form its own node as determined by the system, either at the direction of a user or by the system. To avoid clutter, additional vehicles may be shown and accessed via a scrolling menu. In the present example, all four vehicles are associated with a vehicle node selected via the vehicle tab indicator 104.

Information about each vehicle is accessible to the system via an initialization procedure. As noted, many manufacturers offer Apps tailored to interrogating the attributes of a vehicle of a specified make and or model. Unfortunately, this leads to a scenario where one must execute and utilize a number of different applications in order to gain a perspective on all of the cars under a user’s ownership. Present embodiments encompass various methodologies by which information may be obtained by the system regarding the status of a variety of electric vehicles regardless of make and model and, further, may communicate with individual vehicles so as to alter each vehicle’s operation or stored attributes. Such communication may occur directly between the system and electric vehicles via wired or wireless communication, may rely upon an intermediate data storage device, such as the cloud to which and from which data may be pushed and pulled or some mix of the two.

Because each make and model of an electric vehicle differs in the vehicle attributes it stores and its capabilities, e.g., remote locking doors, remote tire pressure access, etc., it may be the case that the system makes use of a generic electric car API to communicate with all electric vehicles compliant with the generic API. In some instances, it may be necessary to utilize an API unique to a make and model of electric vehicle. In some instances, the system may interrogate a vehicle upon encounter in a manner analogous to the way in which a smartphone may be paired with a Bluetooth device. Specifically, the system, operating on a smartphone or other computing device identifies vehicles in proximity to the device and allows the user to select a vehicle for initialization. Once selected, the system may retrieve a template structure for populating via an API specific to the make and model of the vehicle or, rather, may interrogate the vehicle and establish the capabilities of the vehicle from a generic list of API commands.

Regardless of the method by which the system establishes contact with each vehicle, the result is the ability of the system to communicate with each vehicle and to enable interaction with each vehicle in a standardized fashion. In some embodiments, the system will not allow a vehicle to be registered with the system if the vehicle is unable to perform a minimum set of functionality or transfer a minimum set of attributes. For example, the system may require that each vehicle be capable of reporting battery capacity, current battery charge, charge enablement, etc.

As illustrated, each of the four vehicle summaries 106 is formed of many component parts. Vehicle instance icon 108 identifies a unique vehicle via a visual indicia. In the present instance, a logo of the vehicle make is accompanied by a textual identification of the vehicle. Such a vehicle may be assigned a default textual identifier or may be selected by the user. Charge indicator 110 is a generally rectangular box representing the charge of a battery. As described below, in some instances, charge indicator 110 may take the form of a cylindrical element either partially or fully filled by charge. In the present instance, charge indicator 110 is filled along a horizontal expanse terminating at present charge indicator 114 with a portion lightly shaded. While any color or shading schema may be used in accordance with any exemplary embodiment described herein, the use of light shading may be implemented as the color green and is intended herein to indicate a desired or enabling status. In the present instance, charge indicator 110 represents Ford _1(80, 60, 30, +30). Conversely, dark shading, which may be implemented as the color red, is intended herein to indicate an undesirable or non-enabling status.

Charge request 112 is a value selectable by a slider graphical element and indicated by a horizontal dashed line. At the terminus of charge indicator 110 is an indicia of total battery capacity. In the present example, this indicia is stated in mileage capacity. For example, a typical car battery has a capacity of 75 kWh and can provide approximately 230 miles of travel. Many charging systems restrict a battery from being fully charged. In the present instance, a maximum charge capacity of 210 miles is shown. This number may also be dynamically updated to reflect differences over time in battery capacity resulting from, for example, number of charge cycles, temperature and the like. The user may specify the units of charge. In lieu of mileage capacity, the charge indicator may instead me shown in units of kWh. Likewise, mileage may be shown in kilometers or any other preferred unit.

There is described below a vehicle profile information 122 section of the interface. The system may make use of AI to anticipate future charge consumption use based on past and present charging patterns. In such instances, the user may select to enable an “AI charge enablement” option in the vehicle profile information 122. Enabling such an option may allow the system to adjust the charge request 112 value over time. For example, a user may desire that Ford_1 be charged enough to travel to and from work each day as well make miscellaneous stops on the way home for a total of 79 miles. After a period of time, the user may buy Tesla_2 with which the user makes the miscellaneous excursions on weekends that he previously made on the way home. Over time, the system may deduce a different driving pattern and reduce the daily charge request to 70 miles. In such instances, the system may alert the user to the change via a graphic or audio indicia and request confirmation of the change.

Charge enabled indicator 116 is a graphical indicia that visually indicates the status of each vehicle with regards to its ability to charge or discharge. Charge indicator 116 represents a solid charging connection. Specifically, Ford_1 is either physically connected to a charge station or positioned over a wireless charging pad or the like. Regardless, Ford_1 is capable of being charged in its present state. Charge indicator 116′ shows a lack of any charging connection. As a result, Tesla_2 is unable to charge or discharge at present. Charge indicator 116″ indicates a viable charge connection that is unable to charge at present as indicated by the grayed out indicia.

Note that the charge indicator 110 of Tesla_1 is shaded dark, for red. This shading/color is used in exemplary fashion to indicate a suboptimal condition. In the present example, Tesla_1(75, 10, 75, -65) has a substantially negative Charge. This negative ΔCharge would typically be expected to be accompanied by an indication that the battery is presently charging. For example, charging indicator 118 makes clear that BMW_1 is presently charging. Note that charge source indicator 120 indicates that BMW_1 is being charged using electricity from a reusable energy node of the system, in this case, solar energy. Vehicle selector indicator 124 indicates that the user has touched, clicked or otherwise selected BMW_1. As a result, vehicle profile information 122 is displayed for BMW_1. A series of radio buttons and icons allows the user to specify a charge source. In the present instance, BMW_1 will accept power from reusable energy and an external power provider but not from a home battery node. It is possible that, were one to click on Tesla_1, the accompanying displayed vehicle profile information 122 might show that the only selected charge source is an external power plant. If, at present, the residence at which Tesla_1 is parked is experiencing a blackout, it would explain why a vehicle with a present charge indicator 114 illustrated in red and indicative of needing charge and which is connected so as to receive charge is not charging. Again, specifically, in this example the only source of charge is not selected as an acceptable source of charge.

Continuing, vehicle profile information may further provide a charge override selector 130. Ordinarily, when the system is looking at the entire ecosystem and determining which node and/or sub-node will receive power from or provide power to which other node and/or sub-node, the system may strive to respect charge requests for individual vehicles. For example, if power is needed from the excess power stored in a vehicle’s battery, it may be discharged to provide intra-node or inter-node power distribution. However, without a charge override selection, a vehicle may be prevented from discharging below a charge request 112 selected value. As described more fully below, the system may operate to efficiently move electricity around a charge ecosystem in accordance with set parameters. When one or more charge requirements cannot be met by available or expected sources of electricity, the system may alert the user via one or more text messages, sounds and the like and guide the user through various options to rectify the situation, such as on a smartphone.

Other displayed information may include and economy charge selector 126. This selector 126 allows a user to specify that, when charging from electricity produced by a public utility, charging will only commence when the cost per kWh is at a low level. In some embodiments economy charge selector 126 may further include a method, such as a slider or text entry field, by which a user may specify a value or range of kWh price values at which or within which the vehicle may charge.

Charge history 128 may include a graph or other means of reciting relevant data indicating a history of the vehicle charging. In the present example, the units of charge are kWh as BMW_1 has a 75 kWh capacity battery, Note further the dashed line indicating the 13% charge requested value 112. Manipulating the slider associated with the charge requested value 112 above may cause this dashed line in the graph associated with charge history 128 to dynamically update.

Taking all of this into account, a user may tap on the vehicle tab indicator 104. Tapping on the BMW_1 vehicle summary 106 populates the vehicle profile information 122 with the information illustrated. At a glance, several aspects are clear. First, three vehicles have a present charge in excess of the required minimum charge. Of the three, one of them, BMW_1 is actively charging. It is receiving charge from a solar array forming a part of a renewable energy node. Tesla_2 is fully charged and is not connected to any charging device. Tesla_1 is lacking desired charge and, more importantly, is not charging even though it is connected to a charge device. As described above, the user may click on or touch Tesla_1 vehicle summary 106 to look into what, if anything, should be or can be done to commence charging of Tesla_1.

As a result, a user is able to see in one place the charge profile of one or more electric vehicles and to intuitively alter the characteristics of each individual vehicle. This is true even though each separate make of vehicle may have an individualized mode of communicating with the system or any entity interrogating each vehicle or sending commands to a vehicle. Just as everything in the universe exists in spacetime wherein space and time are inextricably bound to one another, charge anxiety arises from the existence of each user in traveldistance-chargetime. Specifically, “traveldistance-chargetime” refers to the relationship between travel distance and charge time. For example, any distance to be traveled may be expressed in terms of charge required to travel the desired distance. Charge anxiety begins with not knowing if a given amount of charge is sufficient to drive a desired distance or even what that distance is.

In response to this conundrum, the system may operate to provide a connection between an individual vehicle and trip planning information. For example, there may be provided a link, such as directions icon 132, that, when activated, invokes functionality directed to planning a trip. In some instances, the system may interact via an API or other programming interface to an external mapping App to provide mapping functionality.

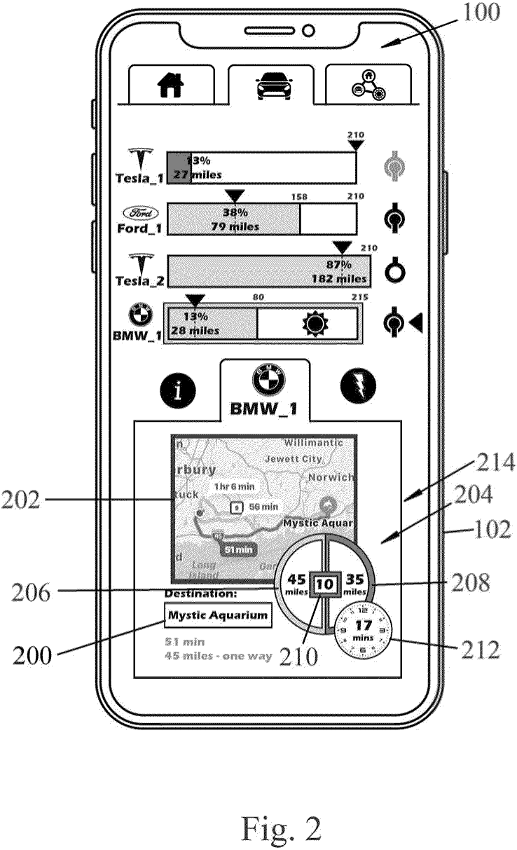

With reference to FIG. 2, there is illustrated an exemplary and non-limiting embodiment of a user interface 100 operating on a computing device 102 showing mapping functionality display 214. In some embodiments, the system components illustrated may be similar in configuration and/or functionality to the system elements illustrated and described with reference to any or all other figures and, as a result, descriptions of FIG. 2 may be combined with the descriptions of any and all other figures. As illustrated, a desired destination entry field 200 enables the user to enter a desired destination. The result of this query is displayed graphically as a map 202. In other embodiments, route information may be displayed in a textual format. In the present instance, a map 202 is displayed showing a plurality of potential routes to Mystic Aquarium. Additional information is provided textually at the bottom whereat the selected and highlighted route is further described as being 51 minutes and 45 miles away.

There is further provided a trip charge summary element 204 providing summary information of the charge status of the prospective trip. In the present example, trip charge summary element is comprised of numerous components. First trip indicator 206 shows the status of the first half of a round trip journey to Mystic Aquarium. As shown, the light gray shading, possibly displayed as green coloring, indicates enough charge to travel 45 miles to the requested destination. To the right, a return trip indicator 208 shows that there will only be enough remaining charge to travel 35 miles. Because this is not indicative of sufficient charge to return, return trip indicator is shown in dark shading/red. Because there is differential of -10 miles between how many miles need to be traveled and how many miles there is sufficient charge to travel, an indication of this 10 miles deficit is shown in a dark shaded box as trip differential 210. Were there to be a surplus or positive differential, both return trip indicator 208 and trip differential 210 would appear as lightly shaded corresponding to a display in green. Associated with return trip indicator 208 is a charge timer 212. Charge timer 212 indicates that 17 minutes of charging is required for the return trip indicator 208 to read “45 miles”, trip differential to read “0” and for both elements to appear as lightly shaded/green.

By way of convention, the state of trip charge summary 204 may be stated as (first trip indicator[green/red][charge timer_1], return trip indicator[green/red][charge timer_2], trip differential[green/red). Using this convention, the previous illustrated example would read as (45 [green][], 35 [red][17], 10[red]). As described and illustrated there is provided information indicative of a needed time of 17 minutes of additional charging until there is exactly enough charge to compete the round trip excursion. As the trip charge summary 204 is dynamically updated during charging, selected snapshots might appear as follows:
T₀: (45 [green][], 35 [red][17], 10[red])
T_{0+5 mins}: (45 [green][], 38 [red][12], 7[red])
T₀₊₁₀ ₘᵢₙₛ: (45 [green][], 41 [red][7], 4[red])
T₀₊₁₇ ₘᵢₙₛ: (45 [green][], 45 [green][0], 0[green])

In order to reduce charge anxiety it is often preferred to include a margin of charging error. For example, there may be utilized a default or user specified margin of charge error. If, for example, the system is using a user specified margin of error of 20%, there may be required enough charge for an additional 18 miles of travel. When this margin of charge error is factored in, the exemplary trip charge summary 204: (45 [green][], 35 [red][17], 10[red]), may read and appear as: (45 [green][], 35 [red][44], 28[red]). In approximately 44 minutes, the exemplary trip charge summary 204 may read as: (45 [green][], 45 [green][], 18[green]). When 44 minutes has passed and all indicators appear as green, the system may alert the user via, for example, an alarm, a textual alert, a message and the like. In some instances, the system may send the destination information, either automatically, at the user’s direction or as the result of defined user preference, to the onboard navigation system of the vehicle. As a result, upon entering the vehicle, the vehicle may recite in summary fashion the attributes of the journey so as to calm the user’s concerns. For example, upon starting the vehicle, the vehicle may broadcast and audio message such as, “Welcome. The scheduled trip to Mystic Aquarium is projected at present to take 51 minutes. You currently have more than sufficient charge to travel roundtrip to your destination.”

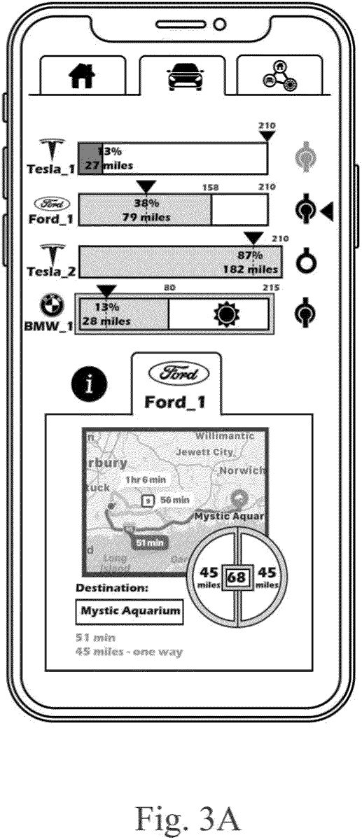

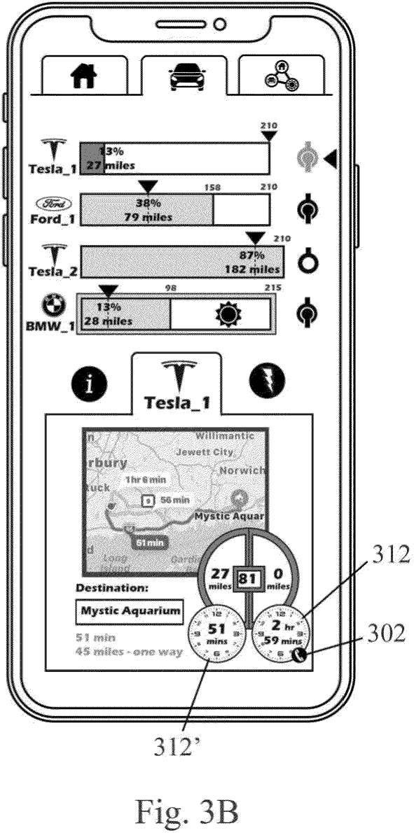

In some embodiments, the requested travel information may persist across vehicles. For example, if the user selects the Ford_1 vehicle summary 106 as indicated by vehicle selector indicator 124 now associated with Ford_1, the mapping functionality display 214 may be updated as shown in FIG. 3A, wherein FIG. 3A is an illustration of a user interface according to an exemplary and non-limiting embodiment. In some embodiments, the system components illustrated may be similar in configuration and/or functionality to the system elements illustrated and described with reference to any or all other figures and, as a result, descriptions of FIGS. 3A and 3B may be combined with the descriptions of any and all other figures. Note that as indicated in the vehicle summary 106, Ford_1 has enough charge to travel 158 miles. As a result, trip differential 210 shows an additional 68 miles of charge capacity.

Next, the user may wish to travel using Tesla_1. If the user selects the Tesla_1 vehicle summary 106 as indicated by vehicle selector indicator 124 now associated with Tesla_1, the mapping functionality display 214 may be updated as shown in FIG. 3B. Note that not only is there insufficient charge to travel even one way to the desired destination, as described above, the grayed out charge enabled indicator 116 indicates that, though plugged in, Tesla_1 is unable to charge. This might result from, for example, a power outage at the residence coupled with the user specifying that power for charging Tesla_1 may only come from a public utility. In such an instance, the user may select the vehicle profile information icon 216 to view vehicle profile information 122 for Tesla_1 and make sure that the radio button for solar electricity is activated. Note that an alert icon 302 in the form of a phone has been appended to the charge timer 312. This informs the user that an alert will be presented to the user such as via text messaging, a visual indicia, a tone, audio explanation, etc. when the vehicle is finished charging to an extent that the round-trip journey may be commenced. In other instances, the user may activate charge timer 312′, such as by touching, and likewise append an alert icon 302 to charge timer 312′. By doing so, the user may be alerted when there is enough charge for the first half of the journey.

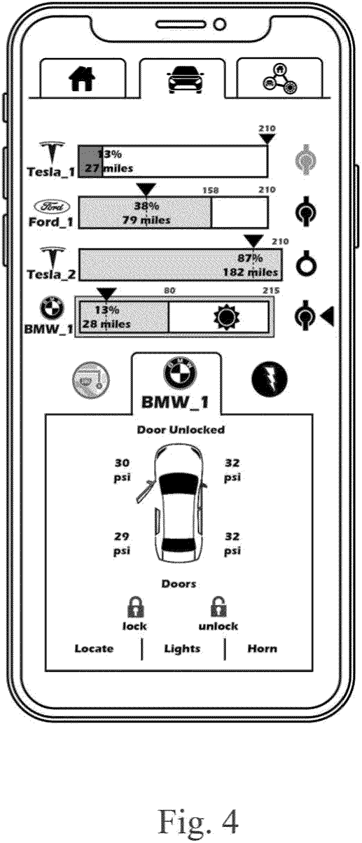

With continued reference to FIG. 2, the user may activate, such as by touching vehicle info icon 134, the display of other miscellaneous vehicle attributes and actions resulting in the exemplary and non-limiting embodiment of FIG. 4. In some embodiments, the system components illustrated may be similar in configuration and/or functionality to the system elements illustrated and described with reference to any or all other figures and, as a result, descriptions of FIG. 4 may be combined with the descriptions of any and all other figures. As illustrated, various non-charging functions are enabled including, but not limited to, checking the tire pressure, observing the lock state of the vehicle, locking the doors, operating the lights, sounding the horn, engaging a pet mode (, etc. While the interface may appear in a consistent manner for all vehicles regardless of make and model, some aspects may be particularized. For example, the rendering of the vehicle from above showing a four door sedan with the front left door unlocked may vary among vehicles to better represent the actual vehicle associated with the displayed data. In some embodiments, gasoline powered vehicles may be included in the display as well with an indicia that the vehicle is not capable of charging. In such instances, there may be displayed a reduced information vehicle summary 106 showing, for example, gallons of gas, gas tank capacity and present driving range.

There has thus far been described a system and methodology for effectively permitting the intuitive and convenient management of the charge status and general status of one or more electric vehicles. As noted, each electric vehicle, in addition to being a mode of conveyance, is a mobile battery. Each vehicle battery is further a battery with often times excess capacity. In some instances, this excess capacity is comprised of stored charge in excess of a specified charge request and in other instances it is comprised of unutilized charge space. In the former instance, the vehicle may form a source of electricity when in a discharging mode and in the later instance, the vehicle may act as an auxiliary storage device for electricity.

While each car is therefore a source of electricity or charge storage, collectively, all connected electric vehicles form a node that in the aggregate possesses excess charge capacity. This node may exist in an ecosystem comprised of various other electricity producing and electricity consuming nodes. For example, rooftop mounted solar cell arrays are increasingly prevalent. Because such arrays typically produce electricity over approximately half the day, there is a need to manage and store excess electricity during the day and to discharge it during the nighttime hours. Increasingly, this excess charge is being stored at home storage battery units. As a result, solar arrays are electricity production nodes. Homes are electricity consumption nodes as well as electricity storage nodes. In many instances, the functioning of each node is tailored to minimize the requirement for the use of electricity provided by an external power source such as a public electricity utility. Such instances are commonly referred to as “off-grid” living. Even when living off-grid, it is common to utilize electricity from public utilities while offsetting such consumption by selling electricity, such as produced by a solar array, to a power grid operator or otherwise redeeming electricity credits with an electricity provider.

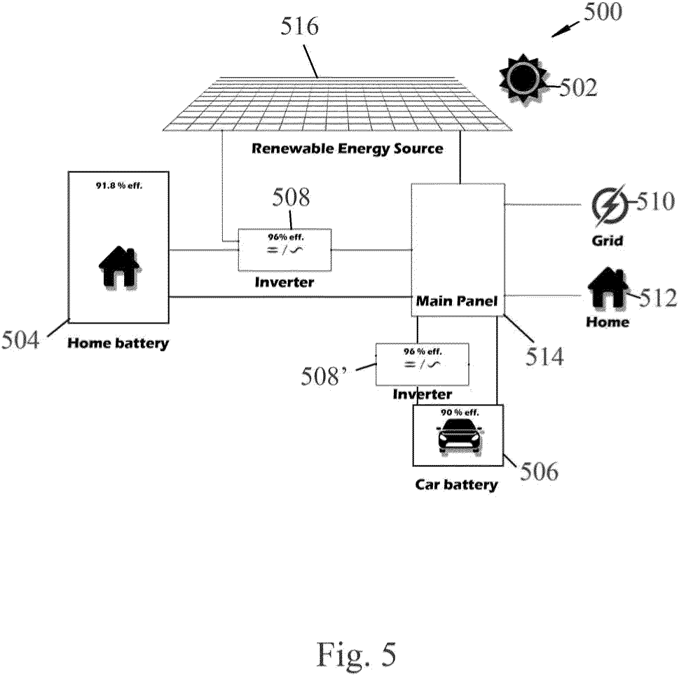

Having described the car charging node consisting of a plurality of electric vehicles, it is noted that a home electricity ecosystem may be comprised of various nodes. With reference to FIG. 5, there is illustrated an exemplary and non-limiting embodiment of a schematic diagram of a home electricity ecosystem 500 comprised of a plurality of nodes. In some embodiments, the system components illustrated may be similar in configuration and/or functionality to the system elements illustrated and described with reference to any or all other figures and, as a result, descriptions of FIG. 5 may be combined with the descriptions of any and all other figures.

Renewable energy node 502, herein referred to also as “solar node”, is comprised of energy generated by renewable sources such as solar panels 516. Solar panels 516 produce DC current and, as described below, may need to have their output passed through an inverter to provide AC current to the main panel 514. By way of example, a typical 60-cell silicon photovoltaic panel is 18.7% efficient at converting sunlight to electricity and produces approximately 320 watts in full sunlight in the northern hemisphere. A typical array of 30 such panels will produce approximately 9.6 kW at any moment. An average day sees the equivalent of approximately 3 hours/day of full sunlight. This equates to the production of approximately 29 kWh/day or approximately 10,600 kWh per year. Note that delivering this electric charge to the main panel via inverter 508 results in a diminution of 4% as the inverter is only 96% efficient at converting from DC to AC power.

Main panel 514 may incorporate the exemplary functions of monitoring electricity use amongst nodes and throughout the ecosystem and enabling switching for routing electricity amongst the nodes and ecosystem entities. Main panel 514 may make use of software or hardware for functioning in an autonomous or semi-autonomous manner, may receive external commands or may function according to a combination of the these modalities. Likewise, while shown as a single entity, main panel 514 may have computing and storage capability distributed throughout the system. For example, main panel 514 may activate switches to provide 7.6 kW from a solar array and 7.5 kW from a public utility to a sub-main panel in communication with each of a plurality of vehicles and which further routes electricity preferentially and differentially to each of the vehicles.

A typical home electricity consumption is approximately 30 kWh/day. As a result, a 30-panel solar array produces approximately as much energy as is consumed by the typical home over the course of a day. As described more fully below, because the array is producing approximately 9.6 kW at peak performance and less and other times, the array will sometimes be producing more energy than a home needs at some times and less energy than is needed at other times throughout the day. For this reason, there may be present a home battery node 504 for storing charge.

Home battery node 504 may be comprised of one or more batteries, typically requiring DC voltage for charging. In some instances, home battery node 504 may be comprised of one or more batteries accepting AC voltage. With regards to such batteries, there is not required the use in many scenarios of inverter 508. Typical home batteries can store approximately 13.5 kWh. An array of three such batteries can store 40.5 kWh or enough energy to power a typical home for a day.

Car battery node 506 may be comprised of one or more batteries each located in a different electric vehicle, typically requiring DC voltage for charging. Typical electric vehicle batteries can store approximately 75 kWh. As a typical electric vehicle uses approximately 33 kWh/100 miles driven, the typical electric car battery can go about 230 miles on a full charge. As a typical driver drives approximately 30 miles/day, an electric vehicle battery requires approximately 10 kWh/day to remain fully charged. In the instance that an owner has more than one electric vehicle, this 10 kWh/day is likely spread to some extent across all electric vehicles. While typically an electricity consuming node, excess charge present in an electric vehicle that is connected in some bi-directional fashion to the main panel may likewise be utilized as a source of power. For example, one may discharge an electric vehicle 506 through inverter 508′ to power home node 512.

Grid node 510 may operate as a producer and a receiver of electricity. In normal operation, grid node 510 is a public utility electricity provider providing AC power. In some instances discussed below, it may be possible for a user to sell electricity back to the grid. As illustrated, the system may operate to select any node source of stored electricity or active electricity producing node to sell or otherwise provide electricity to the grid.

It is contemplated that the system comprises one or more electronic computing devices capable of storing and retrieving data from one or more databases via either a wired or wireless connection. The system may further collect and store data including, but not limited to, user preferences and attributes and electricity consumption and production and the like. System functionality may be achieved via cooperative processing between multiple processors and databases. For example, main panel 514 may operate to sense and record voltage levels of various nodes and components in operation. Such data may be stored in local memory or in the cloud or in another distributed database. Main panel 514 or some other entity may likewise receive voltage and current levels via wireless communication. For example, a user may attach a voltage or electricity measuring device to a node or node device that may operate via wi-fi, Bluetooth or a wired connection to transmit data to a database.

Home electricity ecosystem 500 is a schematic diagram of an exemplary embodiment. Below is disclosed an abstracted view of this schematic embodiment. In accordance with an initialization process, a user enters the identity and attributes of a node or node component into the system for storage. Likewise, a user may manipulate a user interface to make logical connections amongst node entities to fully describe a particular ecosystem. The resulting ecosystem setup may differ in a number of ways from the schematic example presented. For example, there may be one DC home battery and one AC battery rather than the single battery shown. If all AC batteries are used, there may be no need for an external inverter 508. Likewise, a user may not have any renewable energy sources 522. Regardless of the precise topology of a user’s ecosystem, the system may present an abstracted view of the ecosystem consistent with the details of the ecosystem.

For example, a user may buy a second electric vehicle, Tesla_2. The user brings a smartphone running an App on which operates a portion of the system near the vehicle. The user interface on the smartphone App shows a new target node entity comprising a Tesla automobile. The user selects the vehicle to be added to the system and assigns the moniker of Tesla_2 to the vehicle. The system discerns the make and model of the vehicle and operates to download a template for interfacing with the vehicle. The system further adds the vehicle to the definition of the vehicle node for display and user interaction as described above. Likewise, a user may install a solar panel array. The system may prompt the user for a number of solar cells and make and model in order to look up the characteristics of the panels. The user may be further prompted to define a connection topology of the solar cell node, for example, (1) connected to inverter 508 and (2) connected to main panel 514.

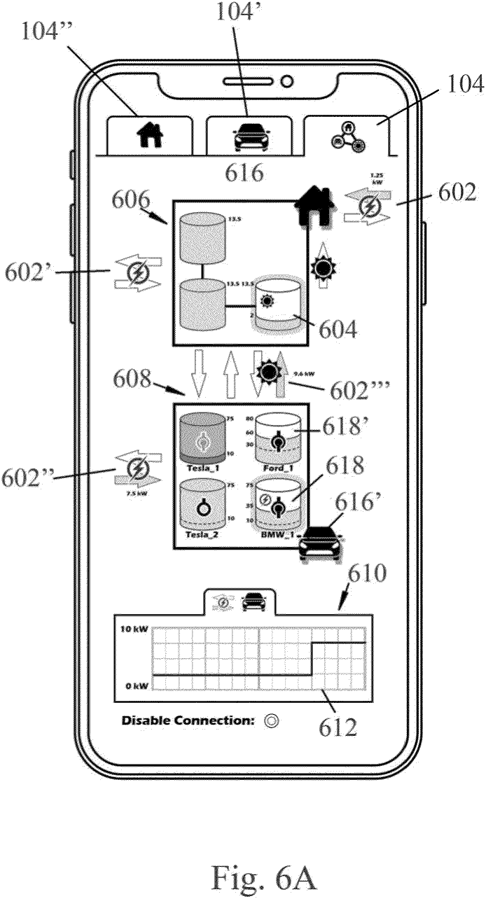

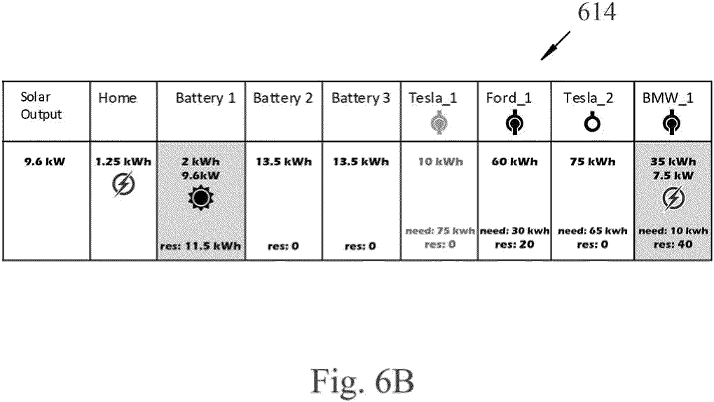

With reference to FIG. 6A, there is illustrated an exemplary and non-limiting embodiment of a user interface with the ecosystem tab indicator 104 activated at a time T₀ as indicated in the exemplary and non-limiting embodiment of a state diagram 614 illustrated in FIG. 6B. In some embodiments, the system components illustrated may be similar in configuration and/or functionality to the system elements illustrated and described with reference to any or all other figures and, as a result, descriptions of FIGS. 6A and 6B may be combined with the descriptions of any and all other figures.

Home node 606, associated via activatable home node icon 616, is comprised of three batteries each storing a maximum of 13.5 kWh. Battery_1, is displayed as having 2 kWh of charge leaving an excess storage capacity of 11.5 kWh as shown in the unshaded white portion. Clicking on home node icon 616 will take one to the home battery interface described more below and operates identically to touching home tab indicator 104″. As indicated in state diagram 614 in the cell corresponding to the charge status of Battery_1, Battery_1 is charging (the cell is lightly shaded gray/green) and, as indicated by the solar icon, is receiving power from a solar array. Likewise, Battery_1 battery icon 604 shows the described relative amounts of charge in light gray/green and excess capacity in white, an indication of total battery capacity of 13.5 kWh and a solar icon indicating that it is receiving 9.6 kW from the solar array. The light gray border around Battery_1 battery icon 104 indicates that it is presently in charging mode.

A plurality of power transmission indictors 602 are shown. Each indicator includes at least one arrow indicating a direction of flow as well as an icon indicating the nature of the source. For example, flow indicator 602″ shows a green arrow indicating flow of charge from a power utility to the electric vehicle node 608. Specifically, 7.5 kW of power is being provided to the electric vehicle node by a public utility. In some instances, light gray/green arrows may further comprise a linear path of dots or the like extending along the expanse of the arrow that are alternatingly intensified or otherwise visually altered in a wave like or sinusoidal fashion to indicate the flow of an entity along the arrow. Note that the cell corresponding to BMW_1 in state diagram 614 is green to indicate active charging from a public utility source. Likewise, BMW_1 battery diagram 618 is surrounded by a light gray/green border indicating an active charge mode and comprises an icon indicating a public utility power source and an enabled charging connection. Note the white portions of various battery diagrams 618 indicating excess charge capacity. In general, light gray/green cylinders are good as they signify that the battery is charged to or in excess of a needed charge. Further note that, in contrast to the descriptions of FIG. 2, BMW_1 is presently being charged by public utility power.

In contrast, Tesla_1 battery diagram 618″ is rendered in red and pink to indicate a problem. In the present instance, as described above, Tesla_1 does not have the requested minimum charge and is plugged in but is presently unable to charge. In the present example, the user has touched or otherwise activated power transmission indicator 602″. In general, touching on a node icon will take one to the user interface associated with the nodes tab indicator. Touching a power transmission indicator 602 may cause the system to access and display power transmission data 610. A tab at the top of power transmission data 610 recites in a pictorial format the source and destination of the flow. In the present example, the two icons read left to right as indicating a public utility power source having the vehicle node as a destination. Power transmission graph 612 shows the history of this charge link whereat, at present, there is being delivered 7.5 kW. There is further provided the option to disable the public utility to vehicle node connection. This might be done if, for example, the user prefers at the moment to not pay for electricity if he does not have to. Conversely, activating a dormant link, such as flow indicator 602′ may offer the user the opportunity to enable or to force the use of a charge link. In some instances, user preferences may be transmitted via spoken speech. For example, the user may say to the APP, “Please disable public power to my cars,” or “Please stop public power to the cars until 7:00 pm today.” In the later instance, the system may disable the connection now and re-implement it at 7:00 pm.

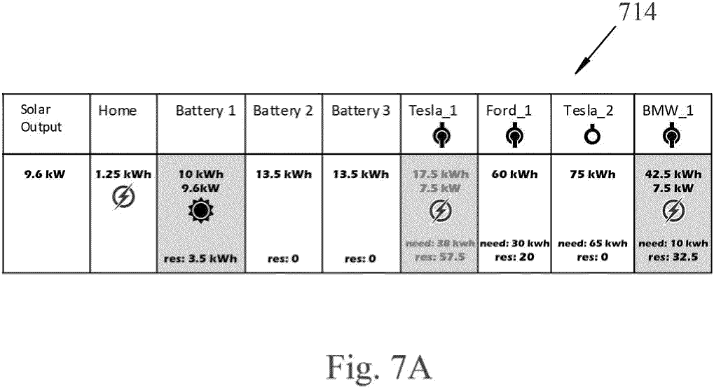

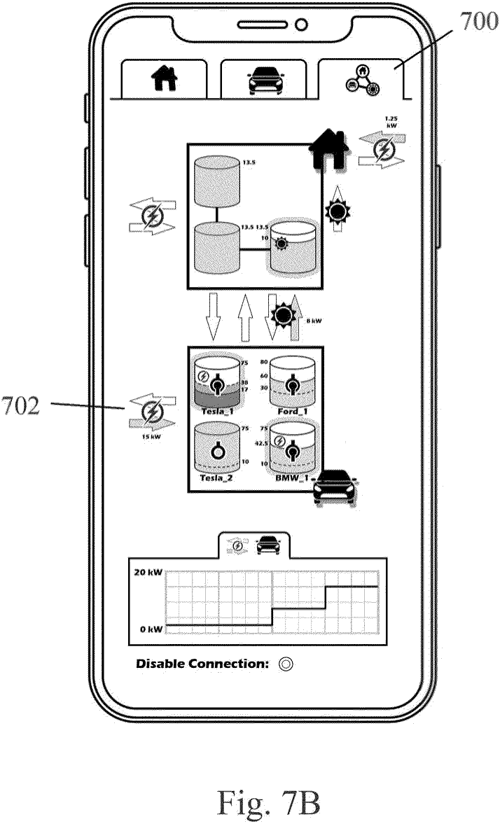

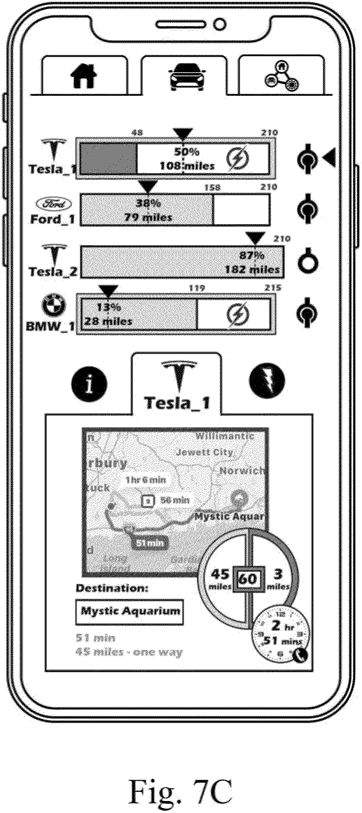

With reference to FIG. 7A, there is illustrated an exemplary and non-limiting embodiment of a state diagram. In some embodiments, the system components illustrated may be similar in configuration and/or functionality to the system elements illustrated and described with reference to any or all other figures and, as a result, descriptions of FIGS. 7A-7B may be combined with the descriptions of any and all other figures. State diagram 714 shows the state of the system at time T₀ + 1 hr. The following differences are apparent when compared with the state diagram 614 at time T₀. Battery_1, having charged for an hour off of solar energy now has 10 kWh of stored charge with a reserve charge capacity of 3.5 kWh. Note that charging for an hour at 9.6 kW should have added an addition 9.6 kWh to the total charge total. The discrepancy is likely attributable to the variable output of the solar panel array. For example, it is possible that over the preceding hour an increasing incidence of clouds resulted in a diminution of solar cell output.

With reference to FIG. 7B, there is illustrated an exemplary and non-limiting embodiment of a user interface with the ecosystem tab indicator 700 activated at a time T₀₊₁ ₕᵣ as indicated in the exemplary and non-limiting embodiment of state diagram 714 illustrated in FIG. 7A. Notable differences with comparison to FIG. 6A include the Tesla_1 battery icon showing a new needed level of charge at 38kWh, a present charge of 17 kWh and an excess charge capacity of 37 kWh. The icon is further updated to show an active connection indicator accompanied by a light gray/green border indicating that Battery_1 is currently charging. As both Tesla_1 battery and BMW_1 battery are currently charging, power transmission indicator 702 now shows 15 kW of instantaneous charge. This is further reflected in the lower graph of the power transmission which shows a jump one hour in the past from 7.5 kW to 15 kW.

With reference to FIG. 7C, there is illustrated an exemplary and non-limiting embodiment of a user interface at time T₀₊₁ ₕᵣ whereby the vehicle tab indicator 704 has been activated. Note that, as indicated, first trip indicator 206 is light gray/green and indicates sufficient charge for the first leg of the journey of 45 miles. Return trip indicator 208 is red indicating charge sufficient to travel only 3 miles of the return leg at present charge. Charge timer 212 is likewise updated to indicate that another 2 hours and 51 minutes is required to provide enough charge to travel the required and remaining 63 miles. Note that charge request 712 selected value has been updated to indicate that enough charge to travel 108 miles is needed.

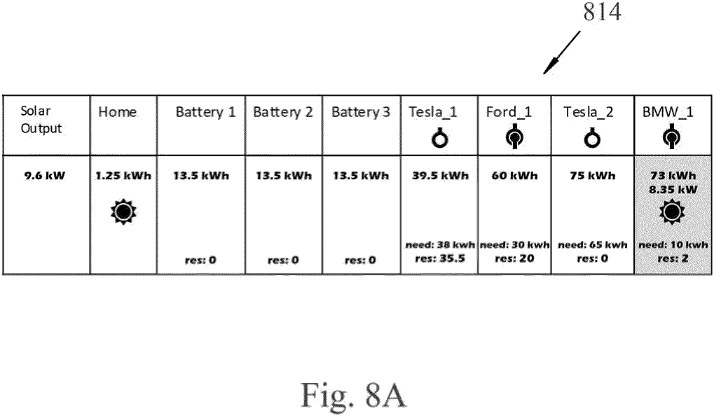

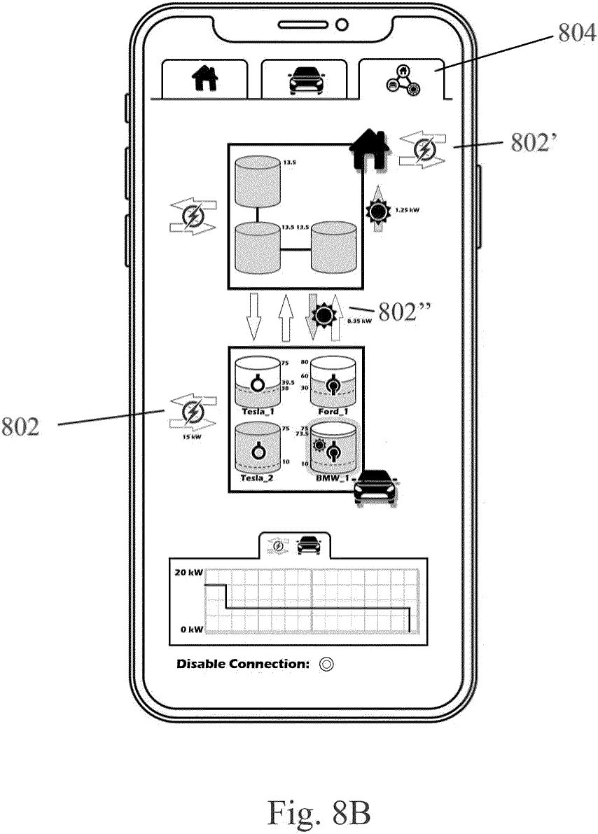

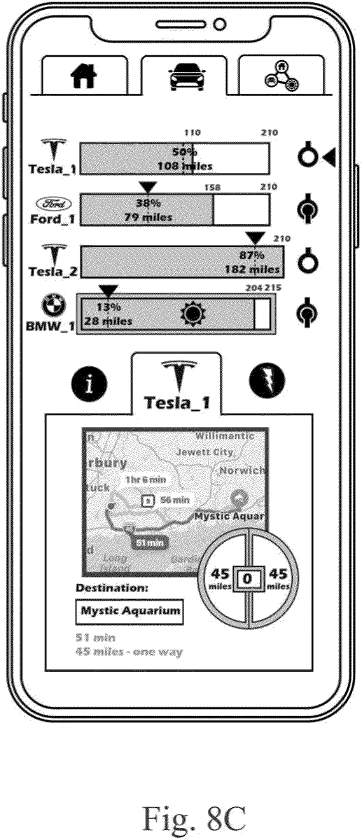

With reference to FIG. 8A, there is illustrated an exemplary and non-limiting embodiment of a state diagram 814. In some embodiments, the system components illustrated may be similar in configuration and/or functionality to the system elements illustrated and described with reference to any or all other figures and, as a result, descriptions of FIGS. 8A-8C may be combined with the descriptions of any and all other figures. State diagram 814 shows the state of the system at time T₀ _{+ 4} ₕᵣ. The following differences are apparent when compared with the state diagram 714 at time T₀₊₁ ₕᵣ. Battery_1, reached full capacity at 13.5 kWh at T₀₊₁ ₕᵣ ₂₁ ₘᵢₙ. At that moment, the system shifted the 9.6 kW produces by the solar array to power the house at 1.2 kW and BMW_1 at 8.35 kW.

With reference to FIG. 8B, there is illustrated an exemplary and non-limiting embodiment of a user interface with the ecosystem tab indicator 800 activated at a time T_{0 + 4} ₕᵣ as indicated in the exemplary and non-limiting embodiment of state diagram 814 illustrated in FIG. 8A. Notable differences with comparison to FIG. 7A include the Tesla_1 battery icon showing a new needed level of charge at 38 kWh, a present charge of 39.5 kWh and an excess charge capacity of 35.5 kWh. The icon is further updated to show an unplugged connection indicator indicating that Tesla_1 is not connected, likely the result of the user having left on his journey. Further, power transmission indicator 802 shows no electrical power transmission. This is further reflected in the lower graph of the power transmission which shows a drop to zero kW. Flow indicators 802′, 802″ show a collective power transmission of 9.6 kW of solar energy.

With reference to FIG. 8C, there is illustrated an exemplary and non-limiting embodiment of a user interface at time T₀₊₄ ₕᵣ whereby the vehicle tab indicator 804 has been activated. Note the absence of a trip indicator as the vehicle is in transit in accordance with the vehicle unplugged icon associated with the Tesla_1 battery icon.

There has thus been described in detail a system and method for facilitating management of one or more electric vehicles via a singular user interface. An advantage of the described system is that a user can easily manipulate the user interface to see the charge status of each vehicle and manage the variables which determine the present and future charging of each vehicle. This is possible without the need to use more than one App each tailored to a specific make and/or model of vehicle. Further, by aggregating a number of electric vehicles in one logical vehicle node, the batteries of all of the vehicles may be manipulated as an aggregated source of charge and charge storage. In the instance where the vehicles are able to discharge electricity back to the home node, the vehicle node acts is a substantial charge storage facility.

Further, by linking travel and direction information to the data underlying the vehicle node, the system can suggest a vehicle for a specific trip based, at least in part, on current charge status, enable charging of a preferred vehicle while displaying to the user the current status of such a vehicle and alert the user to various milestones in the charging profile of the vehicle as it charges, such as when the vehicle has enough charge to complete the journey. This link between each vehicle, both individually and as part of a collective, and travel data for a particular trip aids in reducing charge anxiety.

In the instance that a user of the system further has other charge producing and charge consuming entities, such as a renewable energy resource, the system provides a user interface schema for similarly viewing the instantaneous flow of electricity throughout the ecosystem and the present state of each node and sub-node entity while further enabling the user to enable and disable connections. For example, all four vehicles may be charged to at or above the specified needed charge level and may be in excess of such level by 10 kWh. They may additionally have a collective excess charge capacity of 15 kWh. When the sun is brightest, the solar array may be providing 1.25 kWh to the home with an additional 8.35 kWh going to charging the batteries of several vehicles at the vehicle node. Then, the user may decide to charge a vehicle for a trip. In order to charge the vehicle at the highest possible rate, the system may autonomously divert the 8.35 kW of electric power to be stored in the batteries of the home node while enabling the flow of electric power from a public utility to the vehicle node in order to charge the vehicle at the fastest rate. Likewise, the user may make a preferred alteration in the flow and storage of electric power at any time as described above by selecting a connection or node and altering the attributes via the user interface.

The system may further employ user defined rules, AI and/or a combination of the two to effectively and efficiently move electric power throughout the ecosystem. For example, a user may disable the connection between public utility electric power and the vehicle node. The user may further enable an override of that preference in some defined instances, such as when charging a vehicle for a trip if there is not enough solar energy to charge the vehicle at a maximum rate.

The system may further control the flow of electricity to and from various entities based on various rules. These rules may be default rules, user defined or derived by AI. In general, the system may operate according to a hierarchy of charging rules. For example, the system may operate, whenever possible, to use solar produced power in real time without storing it and losing a percentage of the power to storage inefficiencies. When there is not enough demand for all of the solar produced energy at any moment, the system may preferentially operate to store the excess energy, first at the home node and then at the vehicle node, before attempting to sell the excess power onto the grid. As a result, this schema operates, in general, with respect to solar produced power in a use -> store -> sell hierarchy. AI may operate to alter these rules based upon consumption patterns. For example, a solar panel array may produce 20 kWh per day on average, A house associated with the array may consume approximately 30 kWh per day. This shortfall of 10 kWh will need to come from a public utility at a price between $0.12 /kWh and $0.30 /kWh depending on if it is in the morning or at peak consumption hours. By observing instantaneous electricity pricing over a period of time as well as user consumption habits, the system may store presently produced solar power during times when public electricity is cheap and use it to power the home when prices are more expensive. In short, knowing that the user will be buying, on average, 10 kWh/day off of the grid, the system may apply knowledge gained from the operation of the system to violate the established solar power rule, use -> store -> sell to be store -> use -> sell.

There has been alluded to the possibility of selling excess electric power back on to the grid of a public utility. Logically, this makes much sense as it allows millions of individuals to create millions of points of diffuse electric power generation that is environmentally friendly and may offset the production of electric power by public generation facilities.

In reality, such a schema is fraught with disadvantages. Adding power stored in a DC battery onto a transmission line that transports alternating current requires expensive transformers. The variable nature of the amount of power that individuals produce can wreak havoc on the scheduling of bringing power generation units on and off-line. Transmission costs further add to the inefficiency of the schema.

Individuals would like to be able to sell excess electricity produced by, for example, solar arrays back to the public utility. Public utilities seem disinclined to enable this ability and, regardless, the technical and legal hurdles to so doing render the enterprise of dubious profitability for the individual. Beyond the real time diversion of excess generated electric power, individuals might well engage in a form of arbitrage owing to excess charge storage capacity. For example, an individual might desire to receive public utility electricity and store it when the instantaneous price of electricity is $0.13 /kWh and sell it back to the utility when the price jumps to $0.20 /kWh. However, even if this were possible, the amount earned by a typical household over the course of a day is on the order of a couple of dollars.

In sum, there are substantial hurdles to individuals utilizing their excess generated electricity that prevent its use from being monetized. There are likewise reasons why public utilities would prefer to not encourage the proliferation of the ability of individuals to sell such electricity back onto the grid. This is true despite the benefit to public utilities to be able to tap an additional source of power during unexpected demand spikes which may push the price of producing a kilowatt of power to several dollars per kWh.

There is herein presented a solution to this situation that allows individuals to sell excess generated electric power requiring no additional expensive equipment or transmission costs while providing real benefits to public utility power suppliers. As described above, the present system provides numerous advantages including, but not limited to, (1) the ability to tap the storage capacity of vehicle batteries and to discharge such capacity to any node, including a house as needed, and (2) a robust monitoring and control mechanism for each charge consuming, charge producing and charge storing node or node entity.

Many consumers have a fixed electricity rate plan whereby the consumer is charged a specified and usually a relatively low electricity price for a set term. When electricity prices spike, the utility is forced to take a loss on provided electricity to such consumers. Such losses are difficult to recoup. Atypical 13.5 kWh wall mounted battery in a home is often enough to store just enough excess solar power generated over the course of a day to power the house through the night. As a result there is often little excess capacity though there may well be, as when an additional battery is installed. However, as discussed above, typical car batteries have much greater capacity, typically around 75 kWh of storage. If a user specifies a preference that such a vehicle need only be charged to 80% of capacity, the additional 20% represents enough stored power to meet the electricity needs of a household for a considerable length of time.

The present system therefore allows for the following actions to be taken by public electricity providers and individuals to increase the efficiency of electricity production while offering incentives to both parties to do so. Simply put, the system allows public utilities to access the detailed monitoring data of the system and to instruct the system to shut down some or all node connections that deliver power from the public utility to any node in an individual’s system for a predetermined or dynamically determined length of time while providing for real-time monitoring of the excess charge capacity in the individual’s system.

While any one residence does not form a statistically significant draw on generated power, in the aggregate, millions of homes being switched on and off as desired may significantly reduce demand as needed. Typical utility generators produce several hundred MW. Bringing a new generator on line during a demand spike is costly and leads to price spikes. In one embodiment, as demand spikes, say, by 5 MW, the utility may look at the excess charge capacity of all consumers operating an instance of the described system. The utility may subsequently issue an order to the systems of all or a subset of such users to shut down the node connections coming from the utility. As described above, when a node is shut down, the system operates to reroute stored or generated charge. For example, upon receiving a command to sever connections to public electricity, the system may draw upon excess charge stored in a wall battery or in a vehicle to power the home and possibly vehicles. The utility may monitor, via communication with the system, the excess charge levels and may re-enable provision of electricity when the reserve charge is zero. Conversely, the system may monitor the reserve charge status and issue a request for re-enablement of the provision of public electricity. The utility may prioritize shutting off customers with fixed price contracts.

While shut off from public electricity, the system or utility may monitor the net charge consumption, exclusive of charge swaps such as from a wall battery to a vehicle battery, and credit the user’s account at a predetermined or dynamically calculated price. The result is illustrated by the following example. A user goes to bed at 10:00 with an excess charge in his electric vehicle of 10 kWh. At that time, the user’s residence is drawing 2 kW/hour. At that moment, the utility experiences a price spike to $1.50 /kWh. The utility reacts by issuing instructions to a number of systems, the user’s included, to terminate the consumption of public power. This diminution in demand lowers the price of electricity to $0.20 /kWh. Over the next five hours, the user’s system seamlessly directs excess charge from the vehicle to operate the house. At the end of this time, the system re-enables the acceptance of public electricity. When the user wakes up and looks at his system, he sees that his electric vehicle has less charge than when he went to be but not less than the minimum amount he specified. The utility has credited the user’s account for the provision of 10 kWh at a determined value, say $0.15 /kWh, in the amount of $1.50.

Note that this is advantageous to the public utility even if the price spike is not entirely averted. Providing power to users with a fixed fee contract at, for example, $0.10 /kWh, for five hours when consuming 2 kWh per hour when the price has spiked to $1.50 /kWh costs the provider $15. The provider can only recoup $1.00. There is therefore a considerable range of compensation that the utility would be willing to provide to the user to avoid this scenario.

As a result, each user makes some money at times. In some instances, the excess charge used in the above scenario will have come from a solar array. In effect, the utility is paying the user for the generation of excess solar energy. While this energy was stored and used at a later date rather than being dumped onto the grid as it is generated, the effect is one of compensating the user for power he generates without the added costs and inefficiencies of dumping the power onto the grid. Further, the use of such power is at the controlled and deliberate direction of the utility as needed to load balance and avoid demand surges.

While described with reference to an ecosystem having various nodes including, but not limited to, a home node, an electrical vehicle node and a renewable energy node, the user interface of the system described above may be extended to dive deeper into sub-node and sub-node components which may themselves be further drilled down. For example, clicking or touching the home tab indicator 104, may bring up a view of the home node showing the charge state of a home’s batteries in a manner similar to that of the vehicle battery view shown in FIG. 1. In addition, the home node may be illustrated showing the batteries as but one sub-node in the home node. For example, there may be other sub-nodes such as “Appliances” and/or “lights.” Touching or otherwise selecting “Appliances” may bring up a view showing a refrigerator and a washing machine as nodes or sub-nodes in an appliance ecosystem.

With the advent of Internet of things (IOT), it is increasingly possible to sense in real time the condition and attributes of electric machines. As described, the system provides the ability to start at a level of electricity consuming and producing nodes whereby a user may manage electricity production and consumption and to drill progressively down in a hierarchical fashion. In addition to providing for the display of attributes of various nodes and machines, the system may likewise allow for a user to set relevant attributes and to receive alerts when appropriate when the values of such attributes trip a default or user specified condition.

For example, a user may open the App to a view of the charging ecosystem as shown in FIG. 6A. Clicking on or touching home tab indicator 104 takes the viewer to a view showing a battery node and an appliance node. Touching the appliance node, the user is presented with a display of a refrigerator node/sub-node and a washer node/sub-node. Touching on the refrigerator node, the user is presented with a slider bar to set the temperature of the refrigerator and a scan button. Activating the scan button causes the refrigerator to perform a scan of all products with an RFID code inside the refrigerator and displays the results in a scroll down menu. Moving up a level and back to the slider bar, the user sets the temperature at 10° C. Later, when the user’s son leaves the door to the refrigerator open, the system alerts the user that the temperature has risen to 12° C. These alerts may take any form including, but not limited to, a text message or, alternatively, opening the App to the view of the refrigerator and highlighting a portion of facsimile of a refrigerator associated with the door in red.

### III. Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read. The terms “computer-readable memory” and/or “tangible media” specifically exclude signals, waves, and wave forms or other intangible media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, SAS™ by IGT, OASIS™ by Aristocrat Technologies, SDS by Bally Gaming and Systems, ATP, TCP/IP, GDS published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneider, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A system comprising:
a processor; and
a memory in communication with the processor, the memory storing instructions that when executed by the processor cause the processor to:
(a) receive charge data from a plurality of electric vehicles comprising a first charge node;
(b) display on a touchscreen device the charge data for each of the plurality electric vehicles;
(c) receive one or more user instructions each defining a desired charging attribute for at least one of the plurality of electric vehicles; and
(d) transmit, based upon, at least, one of the received user instructions, updated charge data to at least one of the plurality of electric vehicles.
